(19) United States
(12) Patent Application Publication
(10) Pub. No.: US 2011/0295513 A1
(43) Pub. Date: Dec. 1, 2011

(54) INFORMATION PROCESSING APPARATUS, INFORMATION OUTPUT METHOD, AND PROGRAM

(76) Inventor: SHIGERU OWADA, CHIBA (JP)

(21) Appl. No.: 13/084,648

(22) Filed: Apr. 12, 2011

(30) Foreign Application Priority Data
May 25, 2010 (JP) P2010-119136

(51) Int. Cl. G06F 19/00

(52) U.S. Cl. 702/19

(57) ABSTRACT

There is provided an information processing apparatus including a data acquisition section which acquires input data for recognizing a growth status of a living thing, a recognition section which recognizes a growth status of the living thing based on the input data acquired by the data acquisition section, an agent control section which determines a state of an agent associated with the living thing depending on the growth status of the living thing recognized by the recognition section, and an output section which outputs an agent image corresponding to the state of the agent determined by the agent control section.

### BACKGROUND OF THE INVENTION

1. Field of the Invention

The present invention relates to an information processing apparatus, an information output method, and a program.

2. Description of the Related Art

In related art, there are carried out actions of personifying and representing living things such as animals and plants that exist in the real world. For example, in a blog site, an everyday event, mood, or the like seen from a viewpoint of a pet or a viewpoint of a foliage plant is made available to the public through articles on blogs. The means of personification in blog articles is mainly realized by text-based representation. On the other hand, in Takeshi Nishida, Shigeru Owada, “MOEGI: Plant Fostering by the Assistance of Augmented Reality”, 14th Workshop on Interactive Systems and Software (WISS 2006), pp. 23-26, there is proposed an attempt to display, in augmented reality, an agent which has an appearance of a human being associated with a living thing (plant, for example) that exists in the real world, in order for a user (or reader, listener, or the like) to feel a better bond or joy with the personified living thing.

One of the advantages of representing a status of a living thing by using a personified agent is that there can be used various representations which are free of unnaturalness, compared to the case of causing the living thing itself to virtually perform an action like a human being. Further, there can also be used an agent having different appearance depending on the preference of the user. In the above document “MOEGI: Plant Fostering by the Assistance of Augmented Reality”, a current state of a plant is detected by using various types of sensors, and depending on the state of the plant recognized based on the sensor data, a comical agent performs various actions on the screen.

### SUMMARY OF THE INVENTION

However, in the technology described in the above document “MOEGI: Plant Fostering by the Assistance of Augmented Reality”, although the current state of the plant is recognized based on the sensor data, it is not recognized what status in a growth process the plant is in. Accordingly, the appearance or behavior of the agent is not changed by the growth status of the plant. However, for a user who raises a living thing including a plant in particular, to feel the growing process of the living thing on a daily basis is equally important or more important than to know the current state of the living thing. That is, by allowing the user to feel a growth status of the living thing through changes in the appearance or behavior of the agent on a daily basis, a desire of the user for raising the living thing can be enhanced and the user can be provided with more joy, or it becomes possible to notify the user of the growth status as practical information.

In light of the foregoing, it is desirable to provide an information processing apparatus, an information output method, and a program, which are novel and improved, and which can, through the day-by-day change of appearance or behavior of an agent associated with a living thing of the real world, present the growth status of the living thing to a user.

According to an embodiment of the present invention, there is provided an information processing apparatus including: a data acquisition section which acquires input data for recognizing a growth status of a living thing; a recognition section which recognizes a growth status of the living thing based on the input data acquired by the data acquisition section; an agent control section which determines a state of an agent associated with the living thing depending on the growth status of the living thing recognized by the recognition section; and an output section which outputs an agent image corresponding to the state of the agent determined by the agent control section.

The agent is, for example, a virtual character whose existence is given in an augmented reality (AR) space or a virtual reality (VR) space. The agent presents to the user the growth status of the living thing recognized by the information processing apparatus in various expression forms.

The state of the agent may include at least one of an appearance, an activity level, characteristics of action, characteristics of emotion, and a variation of speech of the agent.

The state of the agent may include an appearance of the agent, and the agent control section may determine an appearance of the agent depending on the growth status of the living thing recognized by the recognition section.

The information processing apparatus may further include a database which stores a growth model that describes a relationship between the input data and growth of the living thing, and the recognition section may recognize a growth status of the living thing based on the input data and the growth model.

The input data may include a living thing image obtained by imaging the living thing, and the recognition section may recognize a growth status of the living thing by image recognition processing using the living thing image as an input image.

The data acquisition section may use a sensor to acquire the input image, the sensor being provided in a vicinity of the living thing and measuring a parameter that influences growth of the living thing or a parameter that changes depending on growth of the living thing.

The data acquisition section may acquire, via a user interface, the input data input by a user who raises the living thing.

The information processing apparatus may further include a communication section which communicates with another information processing apparatus via a network, and the agent control section may cause the agent to perform an action intended for another information processing apparatus via the communication by the communication section.

A frequency of an action of the agent or a range of another information processing apparatus for which an action is intended may change depending on an activity level of the agent corresponding to a growth status of the living thing.

The activity level of the agent may increase at least from an initial stage to a middle stage of growth of the living thing.

The agent control section may cause the agent to perform speech to a user by text or audio, and a content of speech of the agent may be determined based on characteristics of emotion or a variation of speech of the agent corresponding to a growth status of the living thing.

The output section may output a living thing image obtained by imaging the living thing with the agent image superimposed thereon.

The living thing may be a plant.

Further, according to another embodiment of the present invention, there is provided an information output method for outputting information about a living thing by using processor of an information processing apparatus, including the steps of: acquiring input data for recognizing a growth status of a living thing; recognizing a growth status of the living thing based on the acquired input data; determining a state of an agent associated with the living thing depending on the recognized growth status of the living thing; and outputting an agent image corresponding to the determined state of the agent.

Further, according to another embodiment of the present invention, there is provided a program for causing a computer, which controls an information processing apparatus, to function as a data acquisition section which acquires input data for recognizing a growth status of a living thing, a recognition section which recognizes a growth status of the living thing based on the input data acquired by the data acquisition section, an agent control section which determines a state of an agent associated with the living thing depending on the growth status of the living thing recognized by the recognition section, and an output section which outputs an agent image corresponding to the state of the agent determined by the agent control section.

According to the information processing apparatus, the information output method, and the program according to embodiments of the present invention described above, it is possible, through the day-by-day change of appearance or behavior of the agent associated with a living thing of the real world, to present the growth status of the living thing to the user.

### BRIEF DESCRIPTION OF THE DRAWINGS

FIG. 1 is a schematic view illustrating an outline of an information processing system according to an embodiment;

FIG. 2 is a block diagram showing a configuration of an information processing apparatus according to the embodiment;

FIG. 3 is a first explanatory diagram illustrating an example of a growth model according to the embodiment;

FIG. 4 is a second explanatory diagram illustrating an example of the growth model according to the embodiment;

FIG. 5 is an explanatory diagram illustrating a growth status of a living thing recognized by a recognition section according to the embodiment;

FIG. 6 is an explanatory diagram illustrating an example of agent data according to the embodiment;

FIG. 7 is an explanatory diagram illustrating determination of agent data corresponding to a current state;

FIG. 8 is an explanatory diagram showing an example of agent images corresponding to sizes of an agent;

FIG. 9 is an explanatory diagram illustrating determination of agent data corresponding to a state history;

FIG. 10 is an explanatory diagram illustrating determination of agent data corresponding to a state transition;

FIG. 11 is an explanatory diagram illustrating determination of agent data utilizing image recognition processing on a living thing image;

FIG. 12 is an explanatory diagram showing an example of agent images corresponding to types of an agent;

FIG. 13 is an explanatory diagram illustrating a change in an activity level of the agent according to a growth process of the living thing;

FIG. 14 is an explanatory diagram showing a first example of an output image according to the embodiment;

FIG. 15 is an explanatory diagram showing a second example of the output image according to the embodiment;

FIG. 16 is an explanatory diagram showing a third example of the output image according to the embodiment; and

FIG. 17 is a flowchart showing an example of a flow of information output processing according to the embodiment.

### DETAILED DESCRIPTION OF THE EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

Further, the “detailed description of the embodiments” will be described in the order shown below.

1. Outline of information processing system according to embodiment

2. Configuration of information processing apparatus according to embodiment
2-1. Overall configuration example
2-2. Recognition of growth status
2-3. Determination of state of agent
2-4. Communication with another information processing apparatus
2-5. Display of agent image

3. Flow of information output processing according to embodiment

4. Summary

### 1. Outline of Information Processing System According to Embodiment

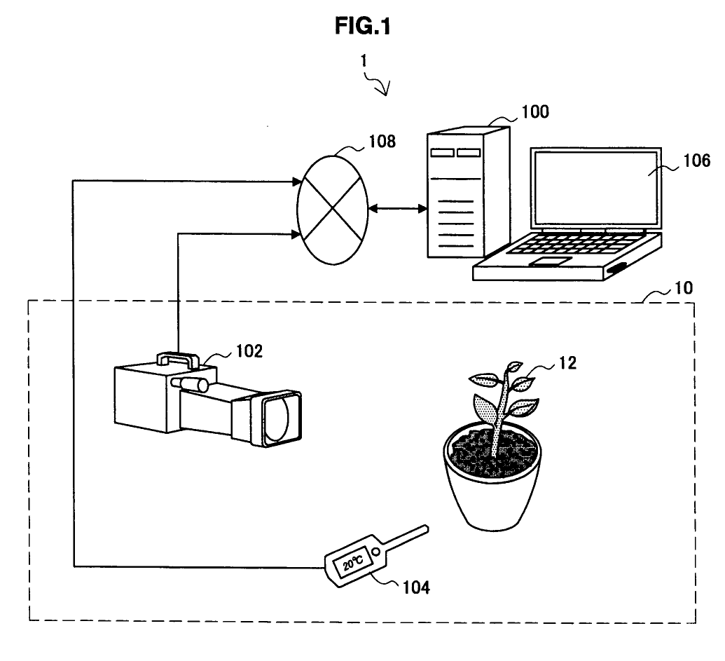

First, by using FIG. 1, an outline of an information processing system according to an embodiment of the present invention will be described. FIG. 1 is a schematic view showing an outline of an information processing system 1 according to the present embodiment. With reference to FIG. 1, the information processing system 1 includes an information processing apparatus 100, an imaging device 102, and sensors 104. The imaging device 102 and the sensors 104 are provided in a raising environment 10 in which a living thing 12 is raised. A network 108 connects the information processing apparatus 100 with the imaging device 102 and the sensors 104.

In the example shown in FIG. 1, the living thing 12 represents a plant planted in a pot. A user raises the living thing 12 within the raising environment 10, and also grasps a growth status of the living thing 12 through an image output from the information processing apparatus 100. Note that the living thing 12 is not limited to the example of FIG. 1 and may be a living thing of another kind. For example, instead of the growth status of the plant, there may be used a growth status of an animal such as a fish, an insect, or a small mammal.

The imaging device 102 is provided so as to face the direction in which the living thing 12 is present, and transmits an input image obtained by imaging the living thing 12 to the information processing apparatus 100. In the present specification, the image which is obtained by imaging the living thing and input to the information processing apparatus 100 is referred to as living thing image.

The sensors 104 are provided in the vicinity of the living thing 12 within the raising environment 10. The sensors 104 measure, for example, a parameter which influences the growth of the living thing 12 or a parameter which changes depending on the growth of the living thing 12. Then, the sensors 104 transmit sensor data which indicates a measurement result to the information processing apparatus 100. As the parameter which influences the growth of the living thing 12, the sensors 104 may measure illuminance, temperature, humidity, and a supply amount of water and fertilizer, for example. Further, as the parameter which changes depending on the growth of the living thing 12, the sensors 104 may measure a weight of the living thing 12 or an entire weight of the pot in which the living thing 12 is planted, and change in amounts of oxygen concentration and carbon dioxide concentration in the air, for example. Note that, in the case where the recognition of the growth status of an animal is attempted, there may be measured, as a parameter which influences the growth of the animal and a parameter which changes depending on the growth of the animal, a supply amount of water and feed, and a weight of the animal. Further, instead of the supply amount of water and fertilizer or feed, a binary data indicating the presence or absence of the supply may be used as the parameter.

The information processing apparatus 100 acquires the living thing image transmitted from the imaging device 102 and the sensor data transmitted from the sensors 104 as input data, and recognizes the growth status of the living thing 12. Further, the information processing apparatus 100 has a screen 106. Then, as will be described later, the information processing apparatus 100 displays an agent image corresponding to the recognized growth status of the living thing 12 on the screen 106. The information processing apparatus 100 may be, for example, a versatile information processing apparatus typified by a PC (Personal Computer), or may also be another kind of information processing apparatus such as a digital household electrical appliance, a smartphone, or a game terminal.

The network 108 is a wired communication network or a wireless communication network for connecting the information processing apparatus 100 with the imaging device 102 and the sensors 104. Note that, without being limited to the example of FIG. 1, the imaging device 102 and the sensors 104 may be connected with the information processing apparatus 100 via a different communication network. Further, for example, the imaging device 102 may be a device which is provided in a physically integrated manner with the information processing apparatus 100. The network 108 may also be used for exchanging data between the information processing apparatus 100 and another information processing apparatus, as will be described later.

### 2. Configuration of Information Processing Apparatus According to Embodiment

### 2-1. Overall Configuration Example

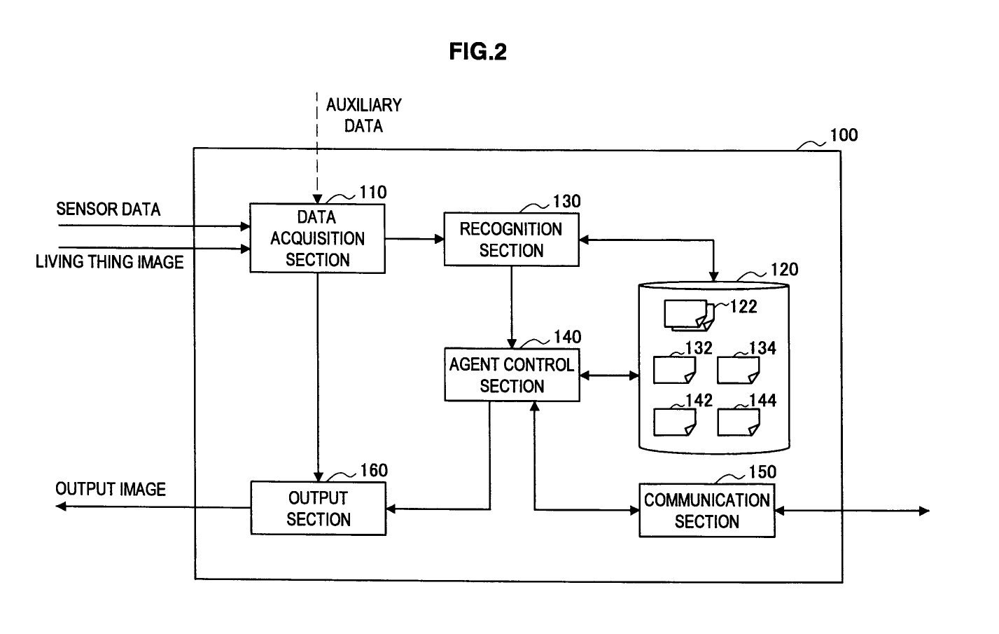

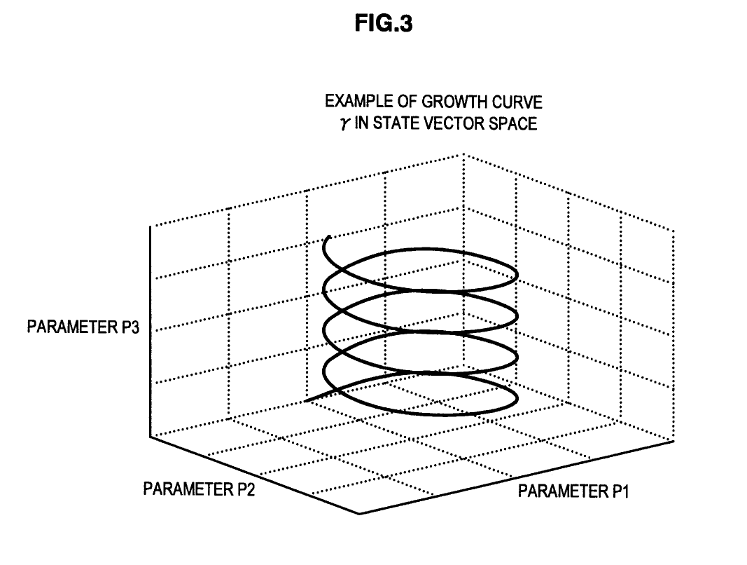

FIG. 2 is a block diagram showing an example of a configuration of the information processing apparatus 100 according to the present embodiment. With reference to FIG. 2, the information processing apparatus 100 includes a data acquisition section 110, a database 120, a recognition section 130, an agent control section 140, a communication section 150, and an output section 160. Hereinafter, the respective sections will be described in more detail with reference to FIGS. 3 to 16.

### 2-2. Recognition of Growth Status

The data acquisition section 110 acquires input data for recognizing a growth status of the living thing 12. Then, the data acquisition section 110 outputs the acquired input data to the recognition section 130 and to the output section 160. In the present embodiment, the input data includes the living thing image received from the imaging device 102 and the sensor data received from the sensors 104. In addition, the data acquisition section 110 may acquire auxiliary data from an external information source. The auxiliary data may also be used, as a part of the input data, for recognizing the growth status of the living thing 12 which is performed by the recognition section 130. The auxiliary data may include, for example, data on weather, temperature, and humidity provided by a weather forecast service.

The database 120 stores various data for processing performed by the information processing apparatus 100 by using a storage medium such as a hard disk or a semiconductor memory. For example, the database 120 stores beforehand a growth model 122, which is data that describes a relationship between the input data and the growth of the living thing, for each kind of the living thing. Further, the database 120 stores a growth log 132 which is a history of a parameter set that is to be the base of the recognition of the growth status, and a state history 134 which is a history of states of the living thing 12 recognized by the recognition section 130. In addition, the database 120 stores an agent model 142 used for determining a state of the agent, and agent data 144 which represents the state of the agent determined by the agent control section 140.

The recognition section 130 recognizes the growth status of the living thing 12 based on the input data acquired by the data acquisition section 110. In the present embodiment, the growth status of the living thing is a concept including a state of the living thing and a change of the state in a series of growth process. More specifically, in the present embodiment, the recognition section 130 recognizes at least a part of the growth status of the living thing 12 based on the growth model 122 which is stored in the database 120 and the input data. Further, the recognition section 130 recognizes another part of the growth status of the living thing 12 by image recognition processing in which the living thing image is used as an input image.

### (1) Example of Growth Status Recognition Based on Growth Model

As described above, in the database 120, there is stored beforehand the growth model 122 which describes a relationship between the input data and the growth of the living thing for each kind of the living thing. In starting to raise the living thing 12, the user registers a kind of the living thing 12 via a user interface of the information processing apparatus 100, for example. Accordingly, the recognition section 130 can use the growth model 122 that corresponds to the registered kind. Instead, for example, a tag (for example, a tag on which a bar code or a QR code is printed, or an RF-ID tag) for identifying a kind of the living thing 12 may be attached to the living thing 12 (or a pot in which the living thing 12 is planted) and the information processing apparatus 100 may recognize the kind of the living thing 12 by reading out the tag.

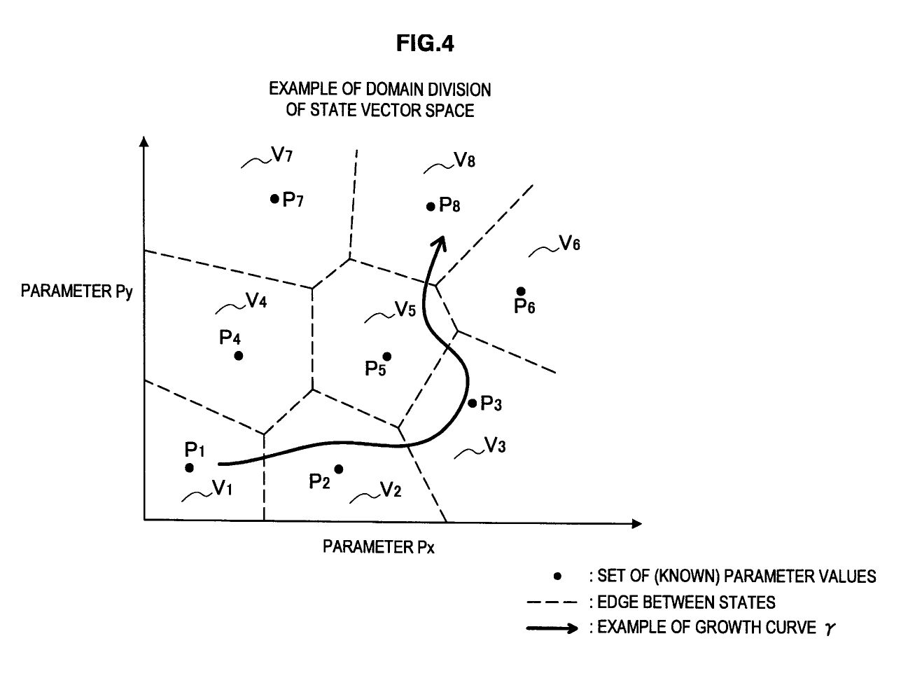

FIGS. 3 and 4 are each an explanatory diagram illustrating the growth model 122.

FIG. 3 shows an example of a growth curve γ of the living thing 12 in a state vector space which is formed by three parameters P1, P2, and P3 determined based on the input data. The parameter determined based on the input data may include, for example, the illuminance, the temperature, the humidity, and the supply amount of water and fertilizer, which are included in the sensor data. Further, the recognition section 130 may also obtain another parameter by modifying those pieces of sensor data. For example, the recognition section 130 may calculate, as a parameter, hours of sunlight per day based on continuously measured illuminance. Further, the recognition section 130 may calculate cumulative temperature from the start of raising the living thing 12, and may use the cumulative temperature as a parameter instead of the temperature. Further, the recognition section 130 may use hours of sunlight or the like estimated from the weather data included in the auxiliary data as a parameter. In addition, the recognition section 130 may recognize the size or the number of leaves (in the case of a plant) of the living thing 12 by analyzing the living thing image, and may use the recognition result as a parameter. Such a parameter set forms a multidimensional state vector space. Although the three-dimensional space is shown for the sake of simplicity of the description in the example of FIG. 3, actually, there may be formed a state vector space having more dimensions. In such a state vector space, when a set of parameter values determined based on the input data are plotted in chronological order, a growth curve γ of the living thing 12 as illustrated in FIG. 3 can be obtained.

In FIG. 4, the state vector space is more simply represented in a two-dimensional plane defined by a parameter Px and a parameter Py. Further, according to the concept of a Voronoi diagram, the state vector space is divided into multiple domains having points P₁ to P₈ as generating points, respectively, the points P₁ to P₈ corresponding to a set of known parameter values, respectively.

The points P₁ to P₈ may be set by, for example, raising beforehand reference samples (that is, samples of the same kind as the living thing 12, which is to be raised for acquiring the growth model 122), and storing parameter values at distinguishing stages in a growth process of the reference samples. Then, the domains including the respective points P₁ to P₈ are defined within the state vector space. An edge between domains may not necessarily be formed along a bisector between generating points like in the Voronoi diagram. For example, an appropriate edge between domains may be defined by an expert with a specialist knowledge on kinds of individual living things or a user who has experience of raising the living things.

Each of the individual states of the living thing 12 in the growth process is associated with any one of the domains. In the example shown in FIG. 4, the set of parameter values belonging to the domain including the generating point P₁ is associated with a state V₁. In the same manner, the sets of parameter values belonging to the domains including the generating points P₂ to P₈, respectively, are associated with states V₂ to V₈, respectively. In the present embodiment, the growth model 122 is data that describes the position of the edge of each domain defined within the state vector space and the correspondence relationship between each domain and a state of the living thing 12.

Accordingly, in recognizing the growth status of the living thing 12, the recognition section 130 plots the set of parameter values determined based on the input data in the state vector space. Next, the recognition section 130 refers to the growth model 122 corresponding to the living thing 12, and acquires a state corresponding to the domain to which the plotted point belongs. The state acquired here (for example, any one of the states V₁ to V₈) represents a current state of the living thing 12. Then, the recognition section 130 additionally writes the acquired current state of the living thing 12 in the state history 134. In the example shown in FIG. 4, the state history of the living thing 12, which grows in accordance with the growth curve γ, includes the states V₁, V₂, V₃, V₅, and V₈ in sequence.

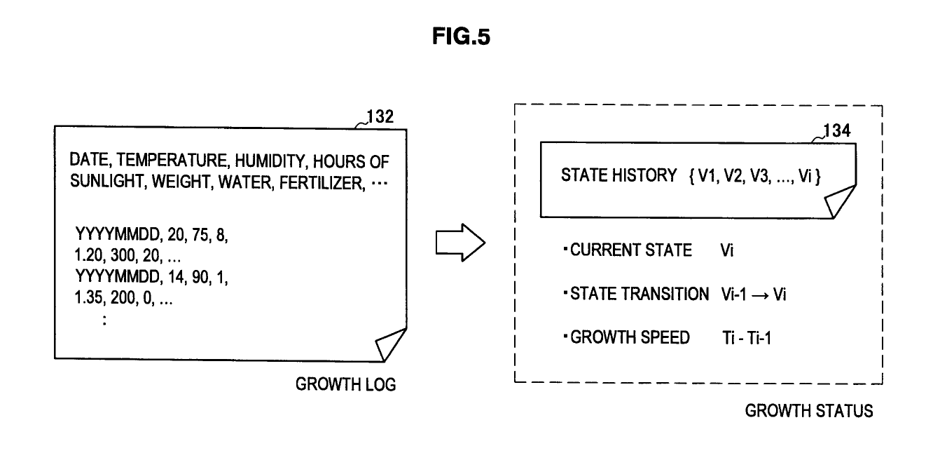

FIG. 5 is an explanatory diagram illustrating a growth status of a living thing recognized by the recognition section 130.

On the left of FIG. 5, there is shown the growth log 132 in which sets of parameter values determined based on the input data are recorded in chronological order. Based on the sets of the parameter values of respective records of the growth log 132, the recognition section 130 recognizes, as described above for example, the state at the present time of the living thing 12 periodically (for example, once per day or once per hour), and records the recognition result in the state history 134. Note that the recording of the state of the living thing 12 may not necessarily be performed periodically, and the state of the living thing 12 may be recorded at the point when there is an instruction from a user or at the point when there occurs a distinguishing change in the state of the living thing 12. On the right of FIG. 5, there is shown state history 134{V₁, V₂, V₃, . . . , Vᵢ} as an example. From the state history 134, it may be recognized as the growth status of the living thing 12 that, in addition to that the current state is represented by Vᵢ, the latest state transition of the living thing 12 is from the state Vᵢ₋₁ to the state Vᵢ. Further, by calculating time difference (Tᵢ−Tᵢ₋₁) between time stamps corresponding to respective states, growth speed of the living thing 12 may also be recognized.

Note that, although there has been described the example in which the growth model 122 is defined for each kind of the living thing 12, instead thereof, a weight by which the parameter value is to be multiplied may be defined for each kind of the living thing 12. In that case, the recognition section 130 multiplies the parameter value determined based on the input data by the weight corresponding to the kind of the living thing 12, and then refers to the growth model 122 which is common to multiple kinds and can recognize the growth status of the living thing 12.

### (2) Modified Example

In addition to the technique of using the state vector space described above (or instead thereof), the growth status of the living thing 12 may be recognized by a simpler technique as will be described below.

For example, by tracking a SIFT (Scale Invariant Feature Transform) feature point in a motion video formed of a series of living thing images each obtained by imaging the living thing 12, the recognition section 130 can detect a rough three-dimensional shape of the living thing 12. In this case, it is desired, by executing segmentation of the image as preprocessing, to leave only the domain on which the living thing 12 is projected and to remove a background of a scene. After that, the recognition section 130 derives the volume (for example, the volume of a convex hull of a feature point set) of the living thing 12 from the detected three-dimensional shape. The recognition section 130 can recognize which stage of the growth processes the living thing 12 is in based on a comparison between the volume of the living thing 12 thus derived and an average volume of the kind to which the living thing 12 belongs, for example.

Further, the recognition section 130 may use weight of the living thing 12 measured by using a weight scale instead of the volume described above. For example, the weight of a plant planted in a pot also changes depending on amounts of water and fertilizer given by the user. However, when the weight is measured for a period of time exceeding a certain length, a measurement result increases along with the growth of the plant. Therefore, the growth status of the living thing 12 can be also recognized by using the simple weight.

Further, in addition to the sensor data from the sensors 104 (or instead thereof), the data acquisition section 110 may also acquire, via a user interface provided by the information processing apparatus 100, data input by the user who raises the living thing 12 as the input data. The data input by the user may include, for example, daily temperature or humidity measured by the user, or amounts of water and fertilizer which the user has supplied the living thing 12 with. The recognition section 130 can also recognize the growth status of the living thing 12 based on such user input data.

In addition, as an even simpler technique, the recognition section 130 may estimate the growth status of the living thing 12 depending on elapsed time from the start of raising the living thing 12.

### 2-3. Determination of State of Agent

The agent control section 140 determines a state of an agent associated with living thing 12 depending on the growth status of the living thing 12 recognized by the recognition section 130. In the present embodiment, the agent control section 140 determines the state of the agent in accordance with the agent model 142 stored beforehand in the database 120. Then, the agent control section 140 causes the database 120 to store the agent data 144 which represents the determined state of the agent.

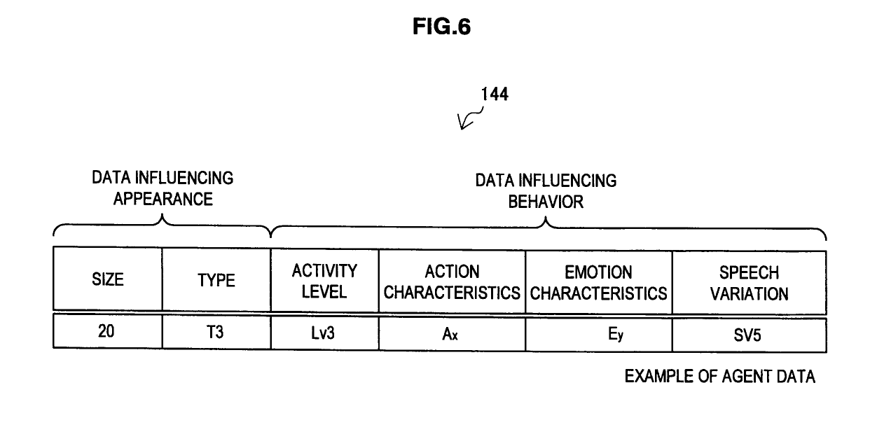

FIG. 6 is an explanatory diagram illustrating an example of agent data according to the present embodiment.

With reference to FIG. 6, the agent data 144 as an example includes six data items: a size and a type which influence an appearance of the agent; and an activity level, action characteristics, emotion characteristics, and speech variation which influence behavior of the agent. Of those, the size represents a size of the agent. The type represents a type of an external appearance of the agent which may be selected from multiple candidates. The activity level is data which influences a frequency and a range of a specific action conducted by the agent. The action characteristics represent characteristics of an action of the agent by a probability vector A. The emotion characteristics represent characteristics of an emotion of the agent by a transition matrix E_{y} having transition probabilities between emotions as elements. The speech variation specifies a set of text which defines the variation of the speech of the agent to the user. The values of those data items may each be determined in accordance with the agent model 142, depending on the growth status of the living thing 12, that is, the state history, the current state, the state transition, or the growth speed of the living thing 12 which has been described using FIG. 5.

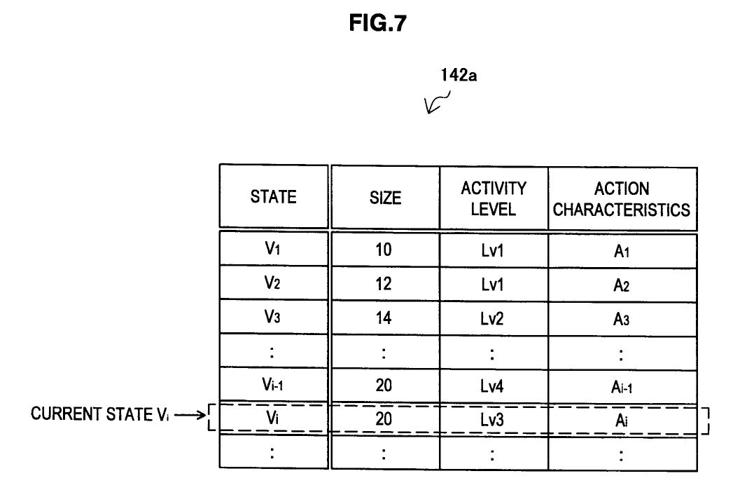

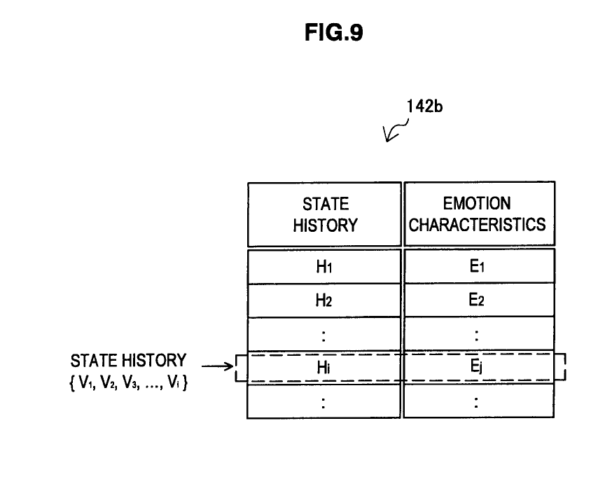

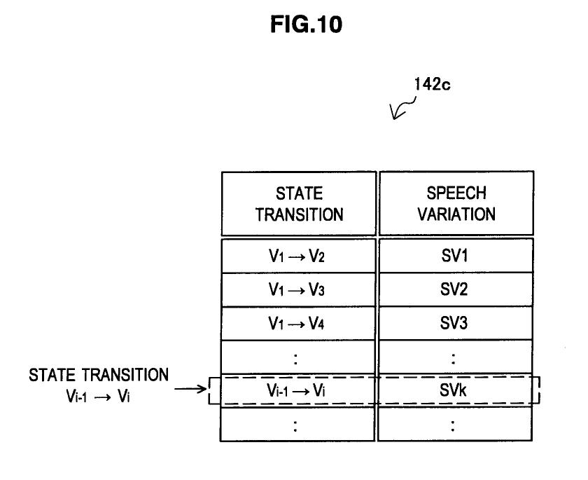

In the present embodiment, the agent model 142 includes, for example, a first agent data determination table 142a illustrated in FIG. 7, a second agent data determination table 142b illustrated in FIG. 9, and a third agent data determination table 142c illustrated in FIG. 10.

FIG. 7 is an explanatory diagram illustrating determination of the agent data corresponding to a current state of a living thing.

In FIG. 7, there is shown the first agent data determination table 142a in which states V₁, V₂, V₃, . . . , Vᵢ₋₁, Vᵢ, . . . , which are candidates for the state of the living thing 12, are each associated with a size, an activity level, and action characteristics of the agent. The agent control section 140 refers to the first agent data determination table 142a, and depending on the current state of the living thing 12 recognized by the recognition section 130, determines the size, the activity level, and the action characteristics of the agent. In the example of FIG. 7, the current state of the living thing 12 is represented by a state Vᵢ. Accordingly, the agent control section 140 specifies the row corresponding to the state Vᵢ in the first agent data determination table 142a, and determines the size, the activity level, and the action characteristics of the agent as follows: size=20; activity level=Lv3; and action characteristics=Aᵢ.

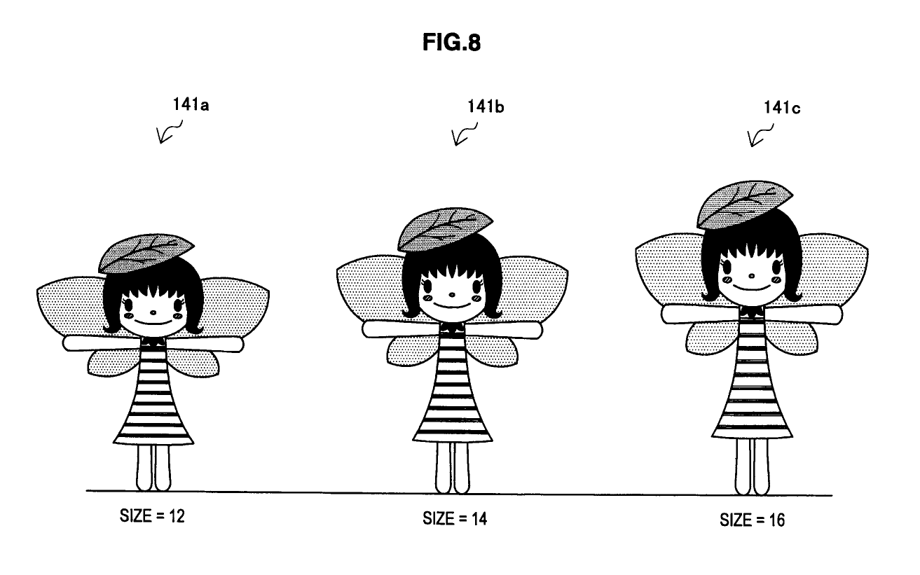

FIG. 8 is an explanatory diagram showing an example of agent images corresponding to sizes of the agent. With reference to FIG. 8, there are shown agent images 141a, 141b, and 141c. Of those, the size of the agent image 141a is 12, the size of the agent image 141b is 14, and the size of the agent image 141c is 16. In this way, the increase in the size of the agent image as the growth of the living thing 12 proceeds can more strongly impress the user with the growth of the living thing 12 through changes in the size of the agent on a daily basis.

The activity level of the user will be described in more detail later.

Table 1 shows an example of a probability vector that expresses characteristics of an action of the agent. In Table 1, there are three actions defined as the actions of the agent, “fly”, “pause”, and “talk”. Further, there are given occurrence probabilities for respective actions. The occurrence probability of “fly” is 0.5. That is, in an output image displayed on the screen, there may be displayed an animation in which the agent is “flying” for 50% of the time period in terms of time. Further, the occurrence probability of “pause” is 0.3, and the occurrence probability of “talk” is 0.2.

TABLE 1
Example of action characteristics

| Action | Fly | Pause | Talk |
|---|---|---|---|
| Occurrence | 0.5 | 0.3 | 0.2 |
| probability | | | |

Note that, the variation of the action of the agent is not limited such an example. Further, there may also be another kind of action, the occurrence probability of which is not defined by the action characteristics. For example, an action of “sleep” of the agent may be displayed independent of the occurrence probability but dependent on time. Further, the frequency of an action “go out”, which will be described later, is determined depending on the activity level described above instead of the occurrence probability which the action characteristics show.

By defining action characteristics as the probability vector for each of the individual states, it becomes possible to produce the following effects as the growth of the living thing 12 proceeds: the agent gradually comes to perform wide variety of actions or to perform different actions for different stages of the growth.

Here, in the case where many state candidates are defined in the growth model, it is difficult to associate all of the states artificially and individually with data values. With regard to such an issue, in the agent model 142, the data value(s) may be associated only with one or some typical state(s). In this case, when a data value corresponding to a current state is absent, the agent control section 140 specifies a state which is the nearest (for example, the Euclidean distance between the generating points is the shortest) to the current state within the state vector space from among states associated with data values in the agent model 142. Then, the agent control section 140 can adopt the data value corresponding to the specified state as the agent data corresponding to the current state. Further, similar techniques may also be applied to the state history, the state transition, and the growth speed.

FIG. 9 is an explanatory diagram illustrating determination of the agent data corresponding to a state history of the living thing.

With reference to FIG. 9, there is shown the second agent data determination table 142b in which states H₁, H₂, . . . , Hᵢ, . . . , which are candidates for the pattern of the state history of the living thing 12, are each associated with emotion characteristics of the agent. The agent control section 140 refers to the second agent data determination table 142b, and depending on the state history of the living thing 12 recognized by the recognition section 130, determines the emotion characteristics of the agent. In the example of FIG. 9, the state history of the living thing 12 is represented by {V₁, V₂, V₃, . . . , Vᵢ}. The agent control section 140 specifies the row corresponding to the state history in the second agent data determination table 142b, and determines that the emotion characteristic of the agent is Eⱼ.

Table 2 shows an example of a transition matrix that expresses characteristics of emotion of the agent. In Table 2, there are defined, as types of emotions of the agent, “joy”, “surprise”, “anger”, and other emotion(s). Further, for each of the pairs of those emotions, an emotion-transition probability is given. For example, the probability that the emotion shifts from “joy” to “joy” (emotion does not change) is 0.5. The probability that the emotion shifts from “joy” to “surprise” is 0.3. The probability that the emotion shifts from “joy” to “anger” is 0.05. The agent control section 140 changes the emotion of the agent depending on the transition probability. Then, from among the candidates of contents defined by the speech variation, for example, the agent talks to the user the content corresponding to the emotion of the agent.

TABLE 2
Example of emotion characteristics

| Emotion | Joy | Surprise | . . . | Anger |
|---|---|---|---|---|
| Joy | 0.5 | 0.3 | . . . | 0.05 |
| Surprise | 0.3 | 0.3 | . . . | 0.2 |
| . | . | . | . | . |
| . | . | . | . | . |
| . | . | . | . | . |
| Anger | 0.05 | 0.1 | . . . | 0.4 |

Note that, the types of the emotion of the agent is not limited to the example shown in Table 2, and there may be used other types such as basic emotions in Plutchik's wheel of emotions (or basic emotions and advanced emotions) (refer to http://www.fractal.org/Bewustzijns-Besturings-Model/Nature-of-emotions.htm).

By defining the emotion characteristics as the transition matrix with respect to each pattern of the state history of the living thing, it becomes possible to produce an effect that the agent comes to have different characters depending on the growth process of the living thing 12.

FIG. 10 is an explanatory diagram illustrating determination of the agent data corresponding to a state transition.

With reference to FIG. 10, there is shown the third agent data determination table 142c in which patterns of the state transition of the living thing 12 are each associated with a speech variation of the agent. The agent control section 140 refers to the third agent data determination table 142c, and depending on the latest state transition of the living thing 12 recognized by the recognition section 130, determines a variation of speech of the agent to the user. In the example of FIG. 10, the state transition of the living thing 12 is represented by Vᵢ₋₁→Vᵢ. The agent control section 140 specifies the row corresponding to the state transition in the third agent data determination table 142c, and determines that the speech variation is SVk. Note that an individual speech variation may be a set of text that defines a content of speech corresponding to an emotion of the agent, for example. Further, there may also be defined a content of speech corresponding to a parameter which is different from the emotion of the agent (for example, temperature or humidity of the raising environment 10, weather recognized from the auxiliary data, number of viewings by the user, or result of communication with another agent).

In this way, by defining different variations of speech with respect to each state transition of the living thing, it becomes possible to produce an effect that the agent comes to talk to the user about various contents depending on the day-by-day change of the state of the living thing 12.

In addition, as will be described next, values of a part of the data items included in the agent data 144 illustrated in FIG. 6 may be determined depending on a result of the image recognition processing in which a living thing image is used as an input image, without using the state history 134.

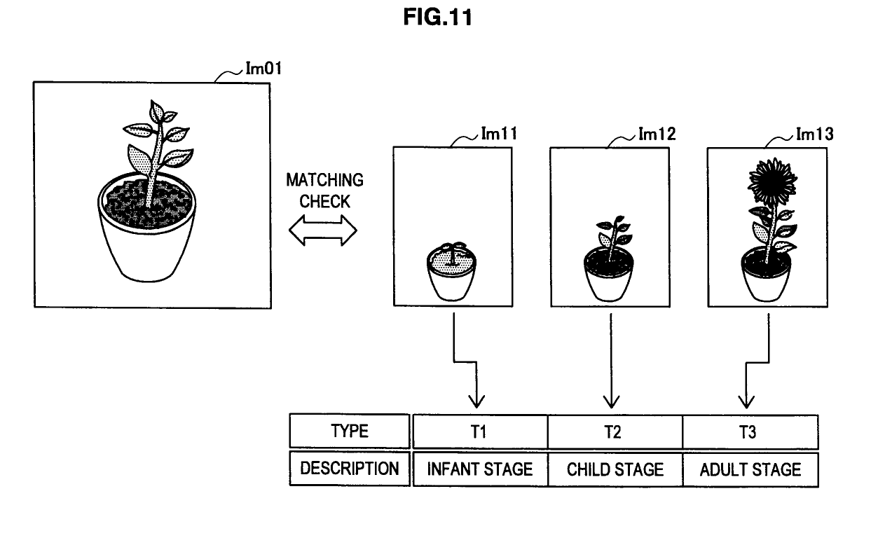

FIG. 11 is an explanatory diagram illustrating determination of the agent data utilizing image recognition processing on a living thing image.

On the top left of FIG. 11, there is shown a living thing image Im01 as an example included in input data. Further, on the top right of FIG. 11, there are shown three kinds of sample images Im11, Im12, and Im13 which are stored beforehand for each kind of the living thing 12. Each of the sample images is an image which shows a typical appearance of the living thing in a typical growth stage for each kind of the living thing. The typical growth stage may be, for example, as for plants, a “sprouting” stage, a “stem-growing” stage, or a “flowering” stage. In the example of FIG. 11, the sample image Im11 is an image of a plant in the “sprouting” stage of the growth. The sample image Im12 is an image of a plant in the “stem-growing” stage. The sample image Im13 is an image of a plant in the “flowering” stage. The recognition section 130 checks the living thing image Im01 against each of the sample images Im11, Im12, and Im13 in accordance with a known pattern matching technique. Then, the agent control section 140 determines, as a type of the agent, a type corresponding to the sample image which is determined to have the highest degree of similarity as a result of the matching check performed by the recognition section 130. For example, in the case where the degree of similarity to the sample image Im11 is the highest, the type of the agent is T1 (“infant stage”). In the case where the degree of similarity to the sample image Im12 is the highest, the type of the agent is T2 (“child stage”). In the case where the degree of similarity to the sample image Im13 is the highest, the type of the agent is T3 (“adult stage”).

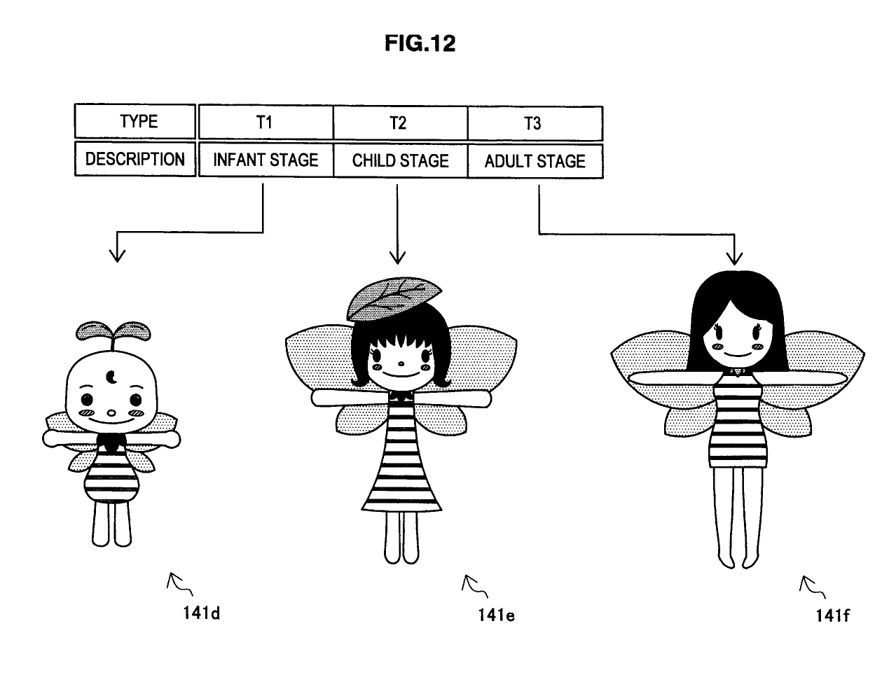

FIG. 12 is an explanatory diagram showing an example of agent images corresponding to types of the agent. In FIG. 12, agent types T1, T2, and T3 are associated with agent images 141d, 141e, and 141f, respectively. In this way, the change in the appearance of the agent depending on the typical growth stage of the living thing 12 can more strongly impress the growth of the living thing 12 on the user, and can also impart to the user a sense of accomplishment corresponding to the progress in the growth.

### 2-4. Communication with Another Information Processing Apparatus

The communication section 150 communicates with another information processing apparatus via the network 108. Then, the agent control section 140 causes the agent to perform an action intended for the other information processing apparatus via the communication by the communication section 150. In the present specification, such an action of the agent intended for the other information processing apparatus is referred to as “going out” of the agent. More specifically, for example, the communication section 150 establishes a communication session with another information processing apparatus having a similar living thing-raising application as the information processing apparatus 100. Then, the agent control section 140 exchanges, with the other information processing apparatus via the communication session, a living thing image, agent data, and other data such as a user name or an agent name. Such data exchange may be virtually represented on the screen in a form of a visit of the agent. The agent which went out while the user is absent (for example, the user is not logged in to the system) presents to the user, when the user logs in afterwards, a living thing image of a living thing that is being raised by another user, which is collected at the destination of the visit. Further, when another agent makes a visit while the user is logged in to the system, there may be displayed on the screen an image of the other agent in addition to the agent of the information processing apparatus 100. In addition, for example, a chat between the users may be performed on the screen in which an agent which went out and another agent which is present at a destination of the visit are displayed. According to such communication, the growth statuses of the living things can be compared with each other between the users raising the living things, and hence, a willingness of the user for raising the living thing becomes even greater. Further, there can be provided an opportunity of formation and activation of a community participated by multiple users.

In the present embodiment, the frequency of the agent's “going out” and the range of another information processing apparatus for which “going out” is intended as described above change depending on an activity level corresponding to the growth status of the living thing. Table 3 shows an example of definitions of a frequency and a range of “going out” of the agent corresponding to the activity level. In Table 3, there are defined five levels, from Lv1 to Lv5, as activity levels of the agent.

For example, in the lowest activity level, Lv1, the frequency of “going out” is “zero” and the range of “going out” is “none”. That is, in the case where the activity level is Lv1, the agent does not go out. In Lv2, the frequency of “going out” is “low”, and the range of “going out” is “limited”. In this case, the frequency of the agent's going out is low, and a destination of the visit of the agent is limited to user(s) of a certain range such as friend user(s) registered beforehand. In Lv3, the frequency of “going out” is “low”, and the range of “going out” is “open”. In this case, although the frequency of the agent's going out is low, a destination of the visit of the agent is not limited (that is, an unknown user may be the destination of the visit as well). In Lv4, the frequency of “going out” is “high”, and the range of “going out” is “limited”. In Lv5, the frequency of “going out” is “high”, and the range of “going out” is “open”.

TABLE 3
Example of activity level

| Activity level | Frequency | Range |
|---|---|---|
| Lv1 | Zero | None |
| Lv2 | Low | Limited |
| Lv3 | Low | Open |
| Lv4 | High | Limited |
| Lv5 | High | Open |

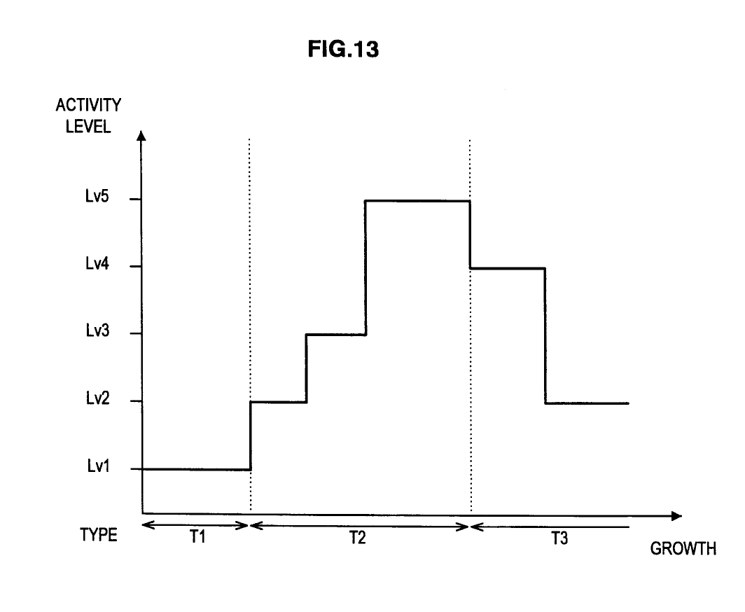

FIG. 13 is an explanatory diagram illustrating a change in an activity level of the agent according to a growth process of the living thing.

In the example shown in FIG. 13, the activity level of the agent increases at least from an initial stage to a middle stage of the growth of the living thing. More specifically, for example, up to the point at which the type of the agent changes from T2 to T3, the activity level of the agent changes in the order of Lv1, Lv2, Lv3, and Lv5. After that, after the type of the agent is changed to T3, the activity level of the agent decreases in the order of Lv4 and Lv2. Those changes in activity levels are based on the following typical action pattern of a human being: the range of action gradually expands from the infant stage to the child stage, and a friendship is deepened with a specific acquaintance when reaching the adult stage. It is expected that, by further enhancing the degree of personification of the agent owing to those changes in the activity levels, the user's friendly feeling toward the living thing and the agent is enhanced.

### 2-5. Display of Agent Image

The output section 160 generates, under the control by the agent control section 140, an agent image depending on a state of the agent. Then, the output section 160 outputs the generated agent image on the screen 106 in a superimposed manner on the living thing image input from the data acquisition section 110. The appearance of the agent in the agent image generated by the output section 160 is determined by a size and a type included in the agent data 144, for example. Further, the output section 160 represents an action of the agent selected based on action characteristics of the agent by using an animation formed of a series of agent images. In addition, the output section 160 displays, on the screen 106, a content of speech selected based on emotion characteristics and speech variation included in the agent data 144 as what the agent says. Instead thereof, the output section 160 may also output the selected speech content by audio.

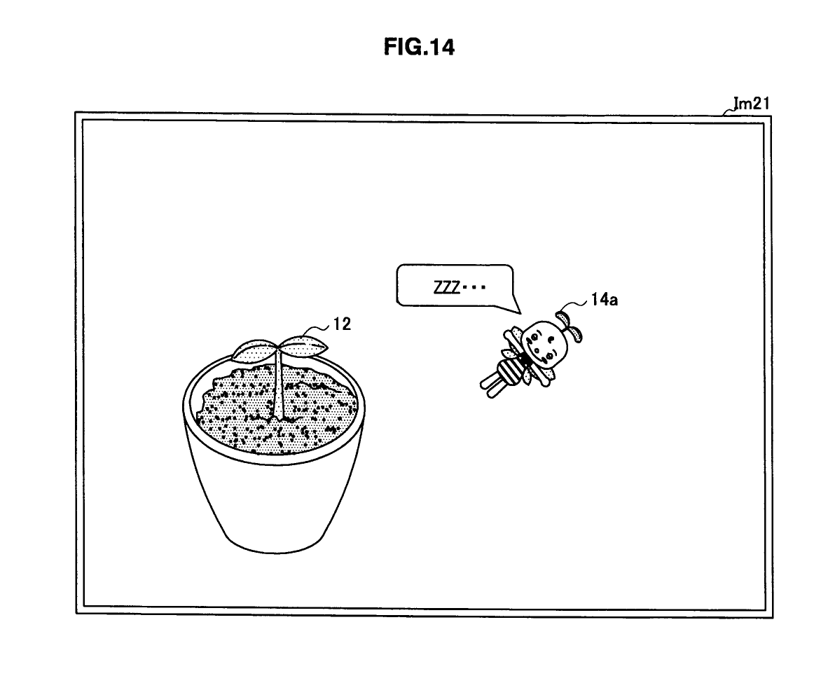

FIGS. 14 to 16 are each an explanatory diagram showing an example of an output image which is output from the output section 160.

The living thing 12 projected on an output image Im21 illustrated in FIG. 14 is a plant in an initial stage of the growth process. An agent image of an agent 14a is superimposed on the output image Im21, in the vicinity of the living thing 12. The agent 14a is an agent which has been personified as a human being in the infant stage, depending on the growth status of the living thing 12.

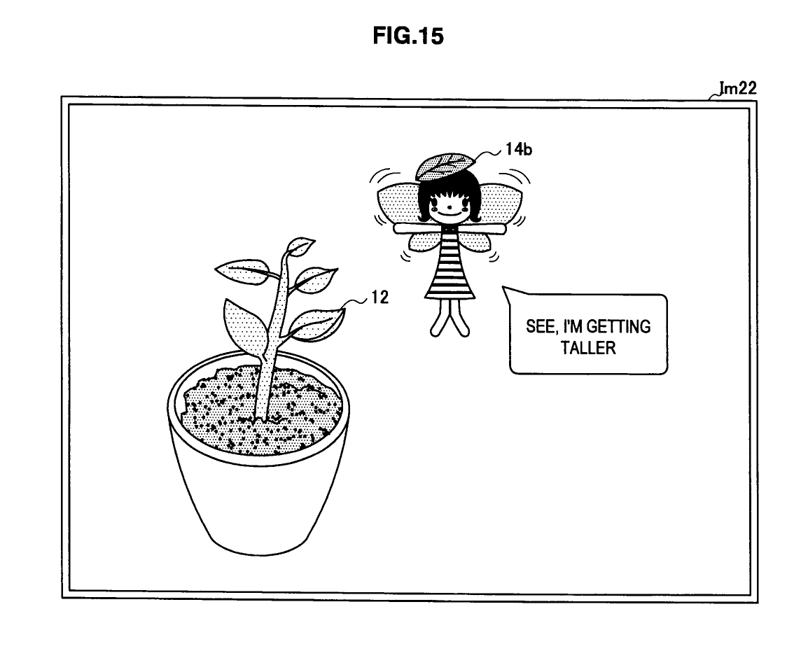

Next, the living thing 12 projected on an output image Im22 illustrated in FIG. 15 is growing more than the living thing 12 shown in FIG. 14. An agent image of an agent 14b is superimposed on the output image Im22, in the vicinity of the living thing 12. The agent 14b is personified as a human being in the child stage, which has grown more than the agent 14a depending on the growth status of the living thing 12. The user can grasp the growth status of the living thing 12 with joy and friendly feeling through the change in the appearance of the agent. Further, the user can also grasp the growth status of the living thing 12 through the content of the speech of the agent 14b indicating that the agent is getting taller, or through an action of the agent 14b of flying around the living thing 12.

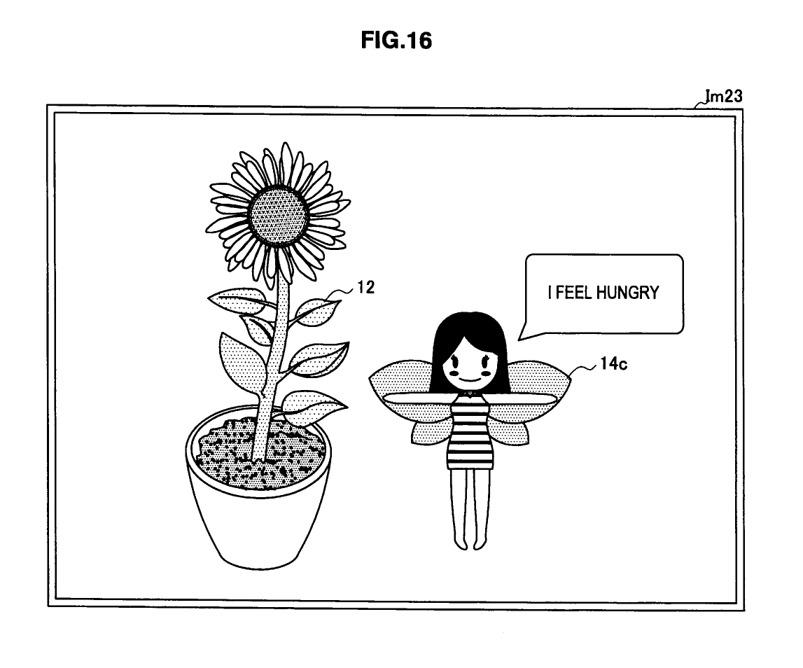

Next, the living thing 12 projected on an output image Im23 illustrated in FIG. 16 is growing still more than the living thing 12 shown in FIG. 15. An agent image of an agent 14c is superimposed on the output image Im23, in the vicinity of the living thing 12. The agent 14c is personified as a human being in the adult stage, which has grown still more than the agent 14b depending on the growth status of the living thing 12. In the same manner as in the case of FIG. 15, the user can grasp the growth status of the living thing 12 through the change in the appearance of the agent. Further, in the example shown in FIG. 16, the agent 14c allows the user to know that the agent 14c feels hungry by speech. Such content of the speech may be selected in the case where an amount of fertilizer is small in the input data acquired by the data acquisition section 110, for example. Accordingly, the user can obtain practical information (that it is necessary to supply fertilizer in this case) which is necessary for raising the living thing 12.

Note that, although not shown, the output section 160 may vary the color or texture of the agent image in accordance with the color or surface pattern of the living thing 12 acquired from the living thing image, for example. Accordingly, in the case where the user is raising multiple living things, for example, the user can easily recognize which agent is associated with which living thing. Further, the output section 160 may change the speed of animation or the speed of speech of the agent image displayed on the screen 106 in accordance with the growth speed of the living thing 12, for example.

Further, the example of the output image is not limited to the examples of FIGS. 14 to 16. For example, in the case where the recognition section 130 recognizes that the living thing 12, which is a plant, is wilting, there may be displayed an agent image which does not look well.

### 3. Flow of Information Output Processing According to Embodiment

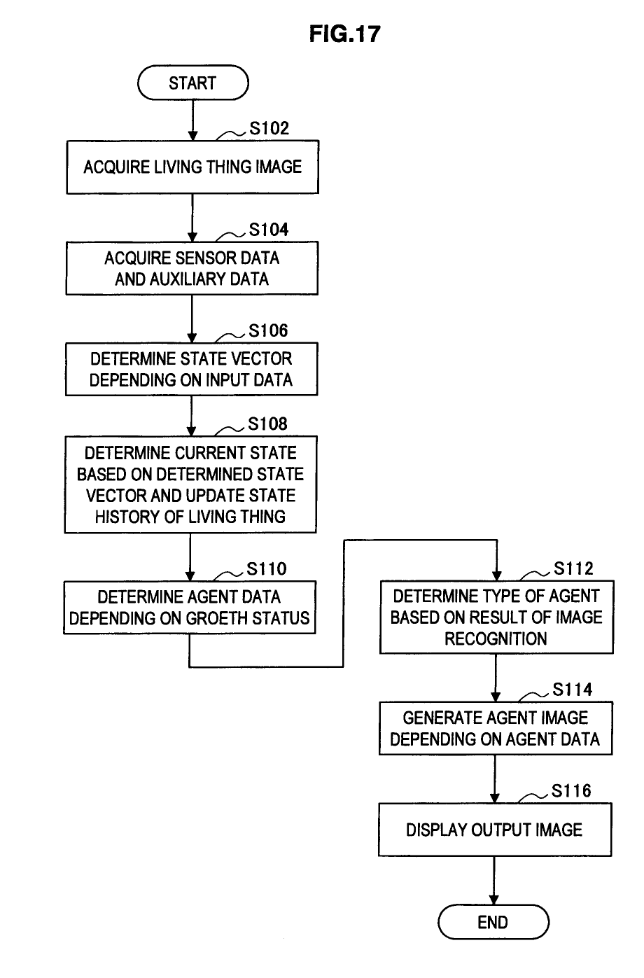

FIG. 17 is a flowchart showing an example of a flow of information output processing performed by the information processing apparatus 100 according to the present embodiment.

With reference to FIG. 17, first, the data acquisition section 110 acquires a living thing image obtained by imaging the living thing 12 from the imaging device 102 (Step S102). Further, the data acquisition section 110 acquires sensor data and auxiliary data, which are for recognizing the growth status of the living thing 12, from the sensors 104 (Step S104). Then, the data acquisition section 110 outputs the living thing image, the sensor data, and the auxiliary data which have been acquired to the recognition section 130 and the output section 160 as input data.

Next, the recognition section 130 determines a state vector of the living thing 12 depending on the input data (Step S106). Next, the recognition section 130 refers to the growth model 122 related to the living thing 12, which is stored in the database 120, and determines a state corresponding to a domain within a state vector space which the state vector of the living thing 12 belongs to as a current state of the living thing 12. Then, the recognition section 130 additionally writes the new current state in the state history 134 of the living thing 12 (Step S108).

Next, the agent control section 140 determines the agent data 144 which represents a state of the agent associated with the living thing 12 depending on the growth status of the living thing 12 recognized by the state history 134 (Step S110). Further, the agent control section 140 determines, as for a part of the agent data 144 (for example, a type), a data value based on a result of the image recognition processing in which the living thing image is used as the input image (Step S112).

Next, the output section 160 generates an agent image corresponding to the state of the agent indicated by the agent data determined by the agent control section 140, and outputs the generated agent image (Step S114). As a result thereof, there is displayed an output image on the screen 106 of the information processing apparatus 100, in which the agent image is superimposed on the living thing image (Step S116).

Among the information output processing performed by the information processing apparatus 100 as shown in FIG. 17, the processing up to Step S112 is periodically performed at a cycle of once per day or once per hour, for example. On the other hand, the generation and the display of the agent image which are performed in the processing from Step S114 onward may be repeated only while the user is logged in to the system, for example.

### 4. Summary

In the above, with reference to FIGS. 1 to 17, the information processing apparatus 100 according to an embodiment of the present invention has been described. According to the present embodiment, a growth status of the living thing is recognized based on the input data such as a living thing image, sensor data, or auxiliary data, and then an image of the agent having different state depending on the growth status is displayed on the screen. Accordingly, it becomes possible, through the day-by-day change of appearance or behavior of the agent associated with a living thing of the real world, to present the growth status of the living thing to the user. As a result thereof, a desire of the user for raising the living thing can be enhanced and the user can be provided with more joy, or it becomes possible to notify the user of the growth status as practical information.

Further, according to the present embodiment, the state of the agent includes: a size and a type which influence an appearance of the agent; and an activity level, action characteristics, emotion characteristics, and a speech variation which influence behavior of the agent. By changing the state of the agent mentioned above depending on the growth status of the living thing, even in the case of raising a plant or a living thing that hardly makes declaration of intention to the user, such as an insect or a reptile, it is possible to allow the user to have a friendly feeling toward the living thing and to allow the user to feel more strongly the growing process of the living thing on a daily basis through the personified agent.

Further, according to the present embodiment, the recognition of the growth status of the living thing is performed by referring to a growth model which is defined beforehand and which describes a relationship between the input data and the growth of the living thing. Accordingly, since the knowledge of an expert with a specialist knowledge or a user who has the raising experience is used through the definition of the growth model, it becomes possible to recognize more accurately the growth status of the living thing. Further, the growth status of the living thing may also be recognized, without using the growth model, based on the image recognition processing in which a living thing image is used as an input image. In that case, an effect of information output according to the present embodiment may be received with a simpler system configuration.

Note that the series of processing performed by the information processing apparatus 100 which has been described in this specification is realized typically by using software. Programs that configure the software for realizing the series of processing are stored beforehand in a storage medium which is internally or externally provided to the information processing apparatus 100, for example. Then, each program is read in a RAM (Random Access Memory) of the information processing apparatus 100 at the time of the execution thereof, and is executed by a processor such as a CPU (Central Processing Unit).

It should be understood by those skilled in the art that various modifications, combinations, sub-combinations and alterations may occur depending on design requirements and other factors insofar as they are within the scope of the appended claims or the equivalents thereof.

The present application contains subject matter related to that disclosed in Japanese Priority Patent Application JP 2010-119136 filed in the Japan Patent Office on May 25, 2010, the entire content of which is hereby incorporated by reference.

What is claimed is:

1. An information processing apparatus comprising:
a data acquisition section which acquires input data for recognizing a growth status of a living thing;
a recognition section which recognizes a growth status of the living thing based on the input data acquired by the data acquisition section;
an agent control section which determines a state of an agent associated with the living thing depending on the growth status of the living thing recognized by the recognition section; and
an output section which outputs an agent image corresponding to the state of the agent determined by the agent control section.

2. The information processing apparatus according to claim 1,
wherein the state of the agent includes at least one of an appearance, an activity level, characteristics of action, characteristics of emotion, and a variation of speech of the agent.

3. The information processing apparatus according to claim 2,
wherein the state of the agent includes an appearance of the agent, and
wherein the agent control section determines an appearance of the agent depending on the growth status of the living thing recognized by the recognition section.

4. The information processing apparatus according to claim 1, further comprising
a database which stores a growth model that describes a relationship between the input data and growth of the living thing,
wherein the recognition section recognizes a growth status of the living thing based on the input data and the growth model.

5. The information processing apparatus according to claim 1,
wherein the input data includes a living thing image obtained by imaging the living thing, and
wherein the recognition section recognizes a growth status of the living thing by image recognition processing using the living thing image as an input image.

6. The information processing apparatus according to claim 1,
wherein the data acquisition section uses a sensor to acquire the input image, the sensor being provided in a vicinity of the living thing and measuring a parameter that influences growth of the living thing or a parameter that changes depending on growth of the living thing.

7. The information processing apparatus according to claim 1,
wherein the data acquisition section acquires, via a user interface, the input data input by a user who raises the living thing.

8. The information processing apparatus according to claim 1, further comprising
a communication section which communicates with another information processing apparatus via a network,
wherein the agent control section causes the agent to perform an action intended for another information processing apparatus via the communication by the communication section.

9. The information processing apparatus according to claim 8,
wherein a frequency of an action of the agent or a range of another information processing apparatus for which an action is intended changes depending on an activity level of the agent corresponding to a growth status of the living thing.

10. The information processing apparatus according to claim 9,
wherein the activity level of the agent increases at least from an initial stage to a middle stage of growth of the living thing.

11. The information processing apparatus according to claim 1,
wherein the agent control section causes the agent to perform speech to a user by text or audio, and
wherein a content of speech of the agent is determined based on characteristics of emotion or a variation of speech of the agent corresponding to a growth status of the living thing.

12. The information processing apparatus according to claim 1,
wherein the output section outputs a living thing image obtained by imaging the living thing with the agent image superimposed thereon.

13. The information processing apparatus according to claim 1,
wherein the living thing is a plant.

14. An information output method for outputting information about a living thing by using processor of an information processing apparatus, comprising the steps of:
acquiring input data for recognizing a growth status of a living thing;
recognizing a growth status of the living thing based on the acquired input data;
determining a state of an agent associated with the living thing depending on the recognized growth status of the living thing; and
outputting an agent image corresponding to the determined state of the agent.

15. A program for causing a computer, which controls an information processing apparatus, to function as
a data acquisition section which acquires input data for recognizing a growth status of a living thing,
a recognition section which recognizes a growth status of the living thing based on the input data acquired by the data acquisition section,
an agent control section which determines a state of an agent associated with the living thing depending on the growth status of the living thing recognized by the recognition section, and
an output section which outputs an agent image corresponding to the state of the agent determined by the agent control section.
